(19) United States
(12) Patent Application Publication
(10) Pub. No.: US 2009/0279894 A1
(43) Pub. Date: Nov. 12, 2009

(54) TRIPLE WAVELENGTH BIDIRECTIONAL OPTICAL COMMUNICATION SYSTEM

(76) Inventors: Jin-Shan Pan, Hsinchu City (TW); Shang-Cheng Liu, Jhubei City (TW); Cheng-Ju Wu, Jhubei City (TW)

Correspondence Address: HDLS Patent & Trademark Services, P.O. BOX 220746, CHANTILLY, VA, 20153-0746, US

(21) Appl. No.: 12/432,935

(22) Filed: Apr. 30, 2009

(30) Foreign Application Priority Data
May 8, 2008 (TW) 097117061

(51) Int. Cl. H04J 14/02; H04B 10/04; H04B 10/06

(52) U.S. Cl. 398/79; 398/182; 398/202

(57) ABSTRACT

A triple wavelength bidirectional optical communication system includes an optical fiber, a transmitter optical subassembly and a receiver optical subassembly. The transmitter optical subassembly includes a first filter, a dual wavelength laser device and a first detector device. The dual wavelength laser device emits a first and a second laser beam to the optical fiber. The first detector device receives a third laser beam emitted from the optical fiber and propagated via the first filter. The receiver optical subassembly includes a second filter, a transceiver device and a second detector device. The transceiver device emits the third laser beam propagated via the second filter and reached to the optical fiber and also receives the first laser beam emitted from the optical fiber and propagated via the second filter. The second detector device receives the second laser beam emitted from the second facet and propagated via the second filter.

### BACKGROUND OF THE INVENTION

1. Field of the Invention

The present invention relates to an optical communication system, in particular to a triple wavelength bidirectional optical communication system.

2. Description of Related Art

The internet provides a platform for exchanging information. Since the amount of transmitted information like video or audio signal is gradually increased on the internet, the maximum transmission bandwidth of a traditional cable will not be enough in the future. That makes optical fiber replaces the traditional cable to provide larger bandwidth for user.

In order to further increase the amount of transmitted information of the optical fiber, wavelength division multiplex (WDM) technology which can transmit information by several light beams with different wavelengths in an optical fiber is applied to increase the amount of transmitted information.

Conventional triple-wavelength bidirectional WDM optical transmission system has a transmitter optical subassembly (TOSA) and a receiver optical subassembly (ROSA) corresponding to the TOSA. The TOSA has two laser devices and one detecting device each packaged by a TO-CAN package. The ROSA has one laser device and two detecting devices each packaged by a TO-CAN package.

However, since the TOSA and ROSA both have bigger size, more complicated structure and higher manufacturing cost, thus limit the popularization of the optical communication. Therefore, it becomes a major issue for manufacturer to provide a TOSA and a ROSA with simplified structure and lower manufacturing cost.

### SUMMARY OF THE INVENTION

The object of the present invention is to provide a triple wavelength bidirectional optical communication system, which has smaller size, simplified structure and lower manufacturing cost.

Another object of the present invention is to provide a TOSA used in a triple wavelength bidirectional optical communication system, which has smaller size, simplified structure and lower manufacturing cost.

Further another object of the present invention is to provide a ROSA used in a triple wavelength bidirectional optical communication system, which has smaller size, simplified structure and lower manufacturing cost.

In order to achieve aforementioned purpose, the present invention provides a triple wavelength bidirectional optical communication system, including an optical fiber, a transmitter optical subassembly and a receiver optical subassembly. The optical fiber has a first facet and a second facet opposite to the first facet. The transmitter optical subassembly includes a first filter optically connected to the first facet, a dual wavelength laser device used to emit a first laser beam and a second laser beam propagated via the first filter and reached to the first facet, and a first detector device used to receive a third laser beam emitted from the first facet and propagated via the first filter, wherein at least one of the first laser beam, the second laser beam and the third laser beam propagates through the first filter is in a reflective approach. The receiver optical subassembly includes a second filter optically connected to the second facet, a transceiver device used to emit the third laser beam propagated via the second filter and reached to the second facet and also used to receive the first laser beam emitted from the second facet and propagated via the second filter, and a second detector device used to receive the second laser beam emitted from the second facet and propagated via the second filter, wherein at least one of the first laser beam, the second laser beam and the third laser beam propagates through the second filter is in a reflective approach.

The present invention also provides a triple wavelength bidirectional optical communication system, including an optical fiber, a transmitter optical subassembly and a receiver optical subassembly. The optical fiber has a first facet and a second facet opposite to the first facet. The transmitter optical subassembly includes a first filter optically connected to the first facet, a laser device used to emit a first laser beam propagated via the first filter and reached to the first facet, and a first transceiver device used to emit a second laser beam and used to receive a third laser beam emitted from the first facet and propagated via the first filter, wherein at least one of the first laser beam, the second laser beam and the third laser beam propagates through the first filter is in a reflective approach. The receiver optical subassembly includes a second filter optically connected to the second facet, a detector device used to receive the first laser beam emitted from the second facet and propagated via the second filter, a second transceiver device used to receive the second laser beam emitted from the second facet and propagated via the second filter and also used to emit the third laser beam propagated via the second filter and reached to the second facet, wherein at least one of the first laser beam, the second laser beam and the third laser beam propagates through the second filter is in a reflective approach.

The present invention also provides a transmitter optical subassembly, including a filter, a dual wavelength laser device and a detector device. The dual wavelength laser device is used to emit a first laser beam and a second laser beam propagated via the filter. The detector device is used to receive a third laser beam, wherein at least one of the first laser beam, the second laser beam and the third laser beam propagated through the filter is in a reflective approach.

The present invention also provides a receiver optical subassembly, including a filter, a transceiver device and a detector device. The transceiver device is used to emit a first laser beam propagated via the filter and used to receive a second laser beam propagated via the filter. The detector device is used to receive a third laser beam, wherein at least one of the first laser beam, the second laser beam and the third laser beam propagated through the filter is in a reflective approach.

The present invention also provides a transmitter optical subassembly, including a filter, a laser device and a transceiver device. The laser device is used to emit a first laser beam propagated via the filter. The transceiver device is used to emit a second laser beam and used to receive a third laser beam propagated via the filter, wherein at least one of the first laser beam, the second laser beam and the third laser beam propagated through the first filter is in a reflective approach.

### BRIEF DESCRIPTION OF THE DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a perspective view of triple wavelength bidirectional optical communication system according to a first embodiment of the present invention;

FIG. 2 is a perspective view of triple wavelength bidirectional optical communication system according to a second embodiment of the present invention;

FIG. 3 is a perspective view of triple wavelength bidirectional optical communication system according to a third embodiment of the present invention; and

FIG. 4 is a perspective view of triple wavelength bidirectional optical communication system according to a fourth embodiment of the present invention.

### DETAILED DESCRIPTION OF THE INVENTION

A detailed description of the present invention will be made with reference to the accompanying drawings.

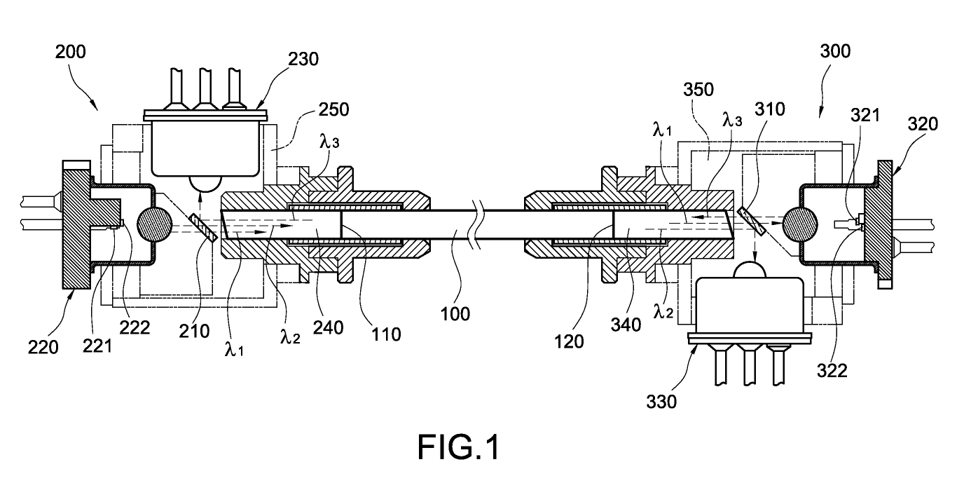

FIG. 1 shows a triple wavelength bidirectional optical communication system according to a first embodiment of the present invention. The optical communication system includes a fiber 100, a transmitter optical subassembly (TOSA) 200 optically connected to the fiber 100, and a receiver optical subassembly (ROSA) 300 optically connected to the fiber 100.

The optical fiber 100 can be a single mode optical fiber or a multi-mode optical fiber, which has a first facet 110 and a second facet 120 opposite to the first facet 110.

The TOSA 200 includes a first filter 210, a dual wavelength laser device 220, a first detector device 230, a fiber stub 240 and a shell 250 used to hold all the above-mentioned components.

The first filter 210 is optically connected to the first facet 110 of the optical fiber 100 in a predetermined angle. In this embodiment, the first filter 210 is a high pass filter, which has a shortwave cutoff wavelength. Light beam which has wavelength shorter than the shortwave cutoff wavelength will not be able to pass through the first filter 210 but is reflected by the first filter 210. Light beam with wavelength longer than the shortwave cutoff wavelength is able to pass through the first filter 210.

The dual wavelength laser device 220 has a first laser chip 221 and a second laser chip 222 packaged together in a TO-CAN package. The first laser chip 221 is used to emit a first laser beam λ1 passed through the first filter 210 and reached to the first facet 110 of the optical fiber 100. The second laser chip 222 is used to emit a second laser beam λ2 passed through the first filter 210 and reached to the first facet 110 of the optical fiber 100. The wavelengths of the first laser beam λ1 and the second laser beam λ2 are both longer than the shortwave cutoff wavelength.

In this embodiment, the first laser chip 221 is a Fabry-Perot edge emitting laser which is made of semiconductor material. The second laser chip 222 is a vertical cavity surface emitting laser (VCSEL) or a horizontal cavity surface emitting laser (HCSEL). In practical use, the dual wavelength laser device which is capable to emit two laser beams with different wavelengths can be any type of structure, and not limited to the above-mentioned structure. In this embodiment, the wavelength of the first laser beam λ1 is 1310 nm, and the wavelength of the second laser beam λ2 is 1550 nm, both are not limited thereto.

The first detector device 230 has a detector chip (not shown) packaged in a TO-CAN package, which is used to receive a third laser beam λ3 emitted from the first facet 110 of the optical fiber 100 and reflected by the first filter 210. The wavelength of the third laser beam λ3 is shorter than the shortwave cutoff wavelength. In this embodiment, the wavelength of the third laser beam λ3 is 850 nm, but not limited thereto in practical use. The wavelength of the third laser beam λ3 is different from the wavelengths of the first laser beam λ1 and the second laser beam λ2.

The fiber stub 240 is used to fix the first facet 110 of the optical fiber 100 in the shell 250.

The ROSA 300 includes a second filter 310, a transceiver device 320, a second detector device 330, a fiber stub 340, and a shell 350 used to hold all the above-mentioned components.

The second filter 310 is optically connected to the second facet 120 of the optical fiber 100 in a predetermined angle. In this embodiment, the second filter 310 is a low pass filter, which has a longwave cutoff wavelength. Light beam which has wavelength longer than the longwave cutoff wavelength will not be able to pass through the second filter 310 but is reflected by the second filter 310. Light beam with wavelength shorter than the shortwave cutoff wavelength is able to pass through the second filter 310.

The transceiver device 320 has a third laser chip 321 and a detector chip 322 packaged together in a TO-CAN package. The third laser chip 321 is used to emit the third laser beam λ3 passes through the second filter 310 and reached to the second facet 120 of the optical fiber 100. The detector chip 322 is used to receive the first laser beam λ1 emitted from the second facet 120 and passed through the second filter 310. The wavelength of the first laser beam λ1 is shorter than the longwave cutoff wavelength.

The second detector device 330 includes a detector chip (not shown) packaged by a TO-CAN package. The second detector 330 is used to receive the second laser beam λ2 emitted from the second facet 120 and reflected by the second filter 310. The wavelength of the second laser beam λ2 is longer than the longwave cutoff wavelength.

The fiber stub 340 is used to fix the first facet 120 of the optical fiber 100 in the shell 350.

In one direction, the first laser chip 221 and the second laser chip 222 of the dual wavelength laser device 220 respectively emit the first laser beam λ1 and the second laser beam λ2 to pass through the first filter 210 to the first facet 110 of the optical fiber 100. The first laser beam λ1 and the second laser beam λ2 in the optical fiber 100 are transmitted to the ROSA 300 from the second facet 120. Then the first laser beam λ1 passes the second filter 310 and transmits to the detector chip 322 and the second laser beam λ2 is reflected by the second detector device 330.

In the opposite direction, the third laser chip 321 of the receiver device 320 emits the third laser beam λ3 to pass through the second filter 310 to reach to the second facet 120 of the optical fiber 100. The third laser beam λ3 in the optical fiber 100 are transmitted to the TOSA 200 from the first facet 110. Then the third laser beam λ3 is reflected by the first filter 210 and transmits to the first detector device 230.

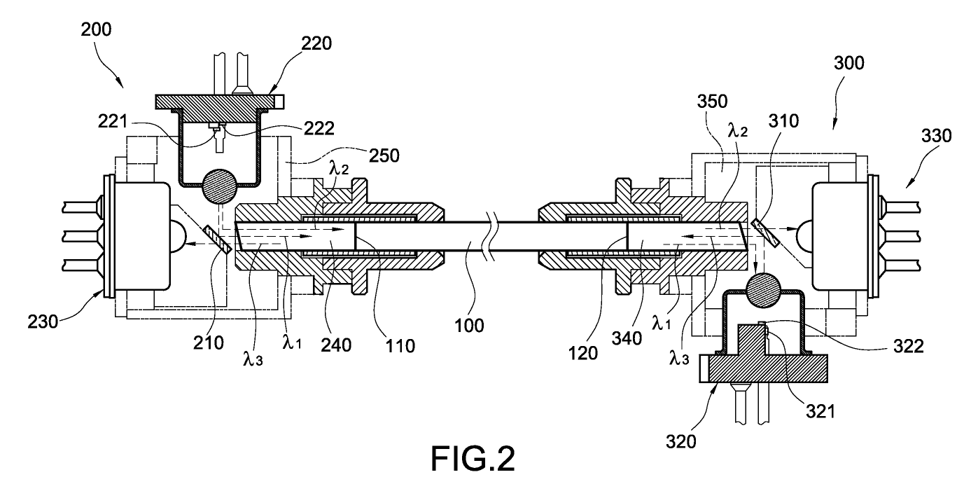

FIG. 2 shows a triple wavelength bidirectional optical communication system according to a second embodiment of the present invention, which is similar to the first embodiment. The difference is that the first filter 210 of the TOSA 200 is a low pass filter, and the second filter 310 of the ROSA 300 is a high pass filter.

In one direction, the first laser chip 221 and the second laser chip 222 of the dual wavelength laser device 220 respectively emit the first laser beam λ1 and the second laser beam λ2 to pass through the first filter 210 and to reach to the first facet 110 of the optical fiber 100. The first laser beam λ1 and the second laser beam λ2 in the optical fiber 100 are transmitted to the ROSA 300 from the second facet 120. Then the first laser beam λ1 is reflected by the second filter 310 and transmits to the detector chip 322. And the second laser beam λ2 passes through the second filter 310 and transmits to the second detector device 330. In the opposite direction, the third laser chip 321 of the receiver device 320 emits the third laser beam λ3 to be reflected by the second filter 310 and to reach to the second facet 120 of the optical fiber 100. The third laser beam λ3 in the optical fiber 100 is transmitted to the TOSA 200 from the first facet 110. Then the third laser beam λ3 passes through the first filter 210 and transmits to the first detector device 230.

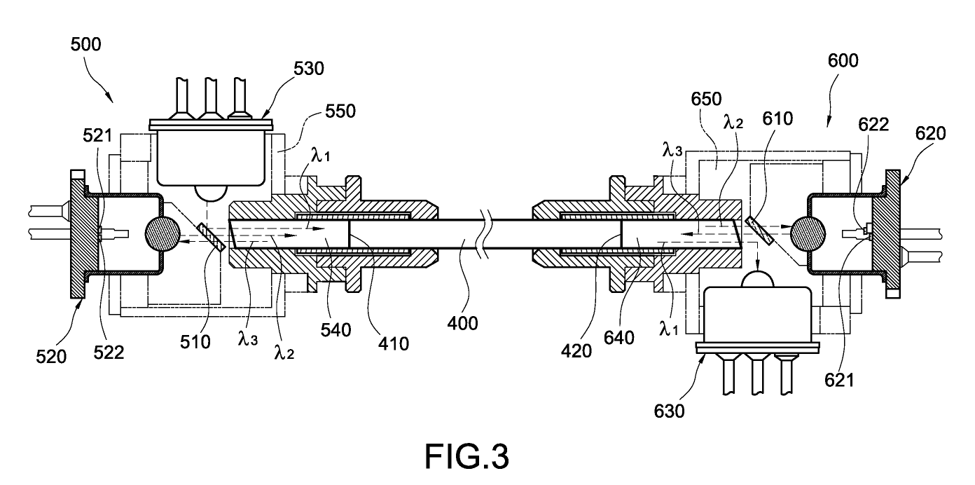

FIG. 3 shows a triple wavelength bidirectional optical communication system according to a third embodiment of the present invention. The optical communication system includes a fiber 400, a transmitter optical subassembly (TOSA) 500 optically connected to the fiber 400, and a receiver optical subassembly (ROSA) 600 optically connected to the fiber 400.

The optical fiber 400 can be a single mode optical fiber or a multi-mode optical fiber, which has a first facet 410 and a second facet 420 opposite to the first facet 410.

The TOSA 500 includes a first filter 510, a laser device 530, a first transceiver device 520, a fiber stub 540 and a shell 550 used to hold all the above-mentioned components.

The first filter 510 is optically connected to the first facet 410 of the optical fiber 400 in a predetermined angle. In this embodiment, the first filter 410 is a low pass filter, which has a longwave cutoff wavelength. Light beam which has wavelength longer than the longwave cutoff wavelength will not be able to pass through the first filter 510 but is reflected by the first filter 510. Light beam with wavelength shorter than the longwave cutoff wavelength is able to pass through the first filter 510.

The laser device 530 has a laser chip (not shown) packaged in a TO-CAN package. The laser device 530 is used to emit a first laser beam λ1 to be reflected by the first filter 510 and reached to the first facet 410 of the optical fiber 400. The wavelength of the first laser beam λ1 is longer than the longwave cutoff wavelength. In this embodiment, the wavelength of the first laser beam λ1 is 1550 nm, but not limited thereto.

The first transceiver device 520 has a first laser chip 521 and a first detector chip 522 packaged together in a TO-CAN package. The first laser chip 521 is used to emit a second laser beam λ2 to pass through the first filter 510 to reach to the first facet 410 of the optical fiber 400. The wavelength of the second laser beam λ2 is shorter than the longwave cutoff wavelength. The first detector chip 522 is used to receive a third laser beam λ3 passed through the first filter 510. The wavelength of the third laser beam λ3 is shorter than the longwave cutoff wavelength. In this embodiment, the wavelength of the second laser beam λ2 is 1310 nm and the third laser beam λ3 is 850 nm, but both not limited thereto in practical use. The wavelength of the first laser beam λ1 is different from the wavelength of the second laser beam λ2, and the second laser beam λ2 is different from the wavelength of the third laser beam λ3.

The fiber stub 540 is used to fix the first facet 410 of the optical fiber 400 in the shell 550.

The ROSA 600 includes a second filter 610, a second transceiver device 620, a detector device 630, a fiber stub 640, and a shell 650 used to hold all the above-mentioned components.

The second filter 610 is optically connected to the second facet 420 of the optical fiber 400 in a predetermined angle. In this embodiment, the second filter 610 is a low pass filter, which has a longwave cutoff wavelength. Light beam which has wavelength longer than the longwave cutoff wavelength will not be able to pass through the second filter 610 but is reflected by the second filter 610. Light beam with wavelength shorter than the shortwave cutoff wavelength is able to pass through the second filter 610.

The detector device 630 includes a detector chip (not shown) packaged by a TO-CAN package. The detector 630 is used to receive the first laser beam λ1 emitted from the second facet 420 and reflected by the second filter 610. The wavelength of the first laser beam λ1 is longer than the longwave cutoff wavelength.

The second transceiver device 620 has a second laser chip 621 and a second detector chip 622 packaged together in a TO-CAN package. The second laser chip 621 is used to emit the third laser beam λ3 passes through the second filter 610 and reached to the second facet 420 of the optical fiber 400. The second detector chip 622 is used to receive the second laser beam λ2 emitted from the second facet 420 and passed through the second filter 410. The wavelength of the second laser beam λ2 is shorter than the longwave cutoff wavelength.

The fiber stub 640 is used to fix the second facet 620 of the optical fiber 400 in the shell 650.

In one direction, the laser device 530 of the TOSA 500 emits the first laser beam λ1 to be reflected by the first filter 510 and to reach to the first facet 410 of the optical fiber 400. The first laser beam λ1 in the optical fiber 400 is transmitted to the ROSA 600 from the second facet 420. Then the first laser beam λ1 is reflected by the second filter 610 and transmits to the detector device 630. The first laser chip 521 of the first transceiver device 520 emits the second laser beam λ2 to pass through the first filter 510. The second laser beam λ2 in the optical fiber 400 is transmitted to the ROSA 600 from the second facet 420. Then the second laser beam λ2 passes through the second filter 610 to reach to the second detector chip 622 of the second transceiver device 620.

In the opposite direction, the second laser chip 621 of the second transceiver device 620 emits the third laser beam λ3 to pass through the second filter 610 to the second facet 420 of the optical fiber 400. The third laser beam λ3 in the optical fiber 400 is transmitted to the TOSA 500 from the first facet 410. Then the third laser beam λ3 passes through the first filter 610 to reach to the first detector chip 522 of the first transceiver device 520.

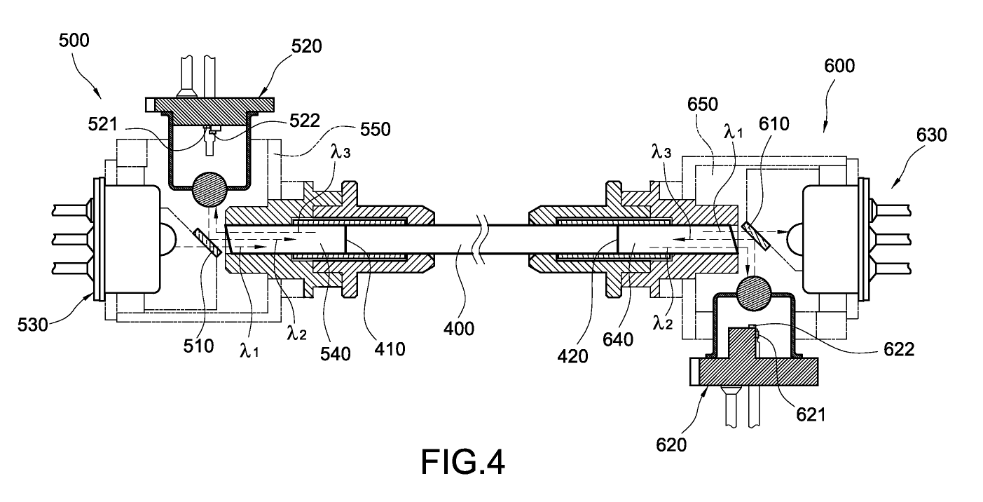

FIG. 4 shows a triple wavelength bidirectional optical communication system according to a fourth embodiment of the present invention, which is similar to the third embodiment. The difference is that the first filter 510 of the TOSA 500 is a high pass filter, and the second filter 610 of the ROSA 600 is a high pass filter.

In one direction, the laser device 530 emits the first laser beam λ1 to pass through the first filter 510 to the first facet 410 of the optical fiber 400. The first laser beam λ1 in the optical fiber 400 is transmitted to the ROSA 600 from the second facet 420. Then the first laser beam λ1 passes through the second filter 610 and transmits to the detector device 630. And the second laser beam λ2 emitted from the first laser chip 521 of the first transceiver device 520 is reflected by the first filter 610 to the first facet 410 of the optical fiber 400. The second laser beam λ2 in the optical fiber 400 is transmitted to the ROSA 600 from the second facet 420. Then the second laser beam λ2 is reflected by the second filter 610 and transmits to the second detector chip 622 of the second transceiver device 620.

In the opposite direction, the second laser chip 621 of the second transceiver device 620 emits the third laser beam λ3 to be reflected by the second filter 610 to the second facet 420 of the optical fiber 400. The third laser beam λ3 in the optical fiber 400 is transmitted to the TOSA 500 from the first facet 110. Then the third laser beam λ3 is reflected by the first filter 510 and transmits to the first detector chip 522.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A triple wavelength bidirectional optical communication system, comprising:
an optical fiber comprising a first facet and a second facet opposite to the first facet;
a transmitter optical subassembly comprising a first filter optically connected to the first facet, a dual wavelength laser device used to emit a first laser beam and a second laser beam propagated via the first filter and reached to the first facet, and a first detector device used to receive a third laser beam emitted from the first facet and propagated via the first filter, wherein at least one of the first laser beam, the second laser beam and the third laser beam propagated through the first filter is in a reflective approach; and
a receiver optical subassembly comprising a second filter optically connected to the second facet, a transceiver device used to emit the third laser beam propagated via the second filter and reached to the second facet and also used to receive the first laser beam emitted from the second facet and propagated via the second filter, and a second detector device used to receive the second laser beam emitted from the second facet and propagated via the second filter, wherein at least one of the first laser beam, the second laser beam and the third laser beam propagated through the second filter is in a reflective approach.

2. The triple wavelength bidirectional optical communication system according to claim 1, wherein the dual wavelength laser device has a first laser chip and a second laser chip packaged together in a TO-CAN package.

3. The triple wavelength bidirectional optical communication system according to claim 2, wherein the transceiver device has a third laser chip and a detector chip packaged together in a TO-CAN package.

4. A triple wavelength bidirectional optical communication system, comprising:
an optical fiber comprising a first facet and a second facet opposite to the first facet;
a transmitter optical subassembly comprising a first filter optically connected to the first facet, a laser device used to emit a first laser beam propagated via the first filter and reached to the first facet, and a first transceiver device used to emit a second laser beam and used to receive a third laser beam emitted from the first facet and propagated via the first filter, wherein at least one of the first laser beam, the second laser beam and the third laser beam propagated through the first filter is in a reflective approach; and
a receiver optical subassembly comprising a second filter optically connected to the second facet, a detector device used to receive the first laser beam emitted from the second facet and propagated via the second filter, a second transceiver device used to receive the second laser beam emitted from the second facet and propagated via the second filter and also used to emit the third laser beam propagated via the second filter and reached to the second facet, wherein at least one of the first laser beam, the second laser beam and the third laser beam propagated through the second filter is in a reflective approach.

5. The triple wavelength bidirectional optical communication system according to claim 4, wherein the first transceiver device has a first laser chip and a first detector chip packaged together in a TO-CAN package.

6. The triple wavelength bidirectional optical communication system according to claim 5, wherein the second transceiver device has a second laser chip and a detector chip packaged together in a TO-CAN package

7. A transmitter optical subassembly, comprising:
a filter;
a dual wavelength laser device used to emit a first laser beam and a second laser beam propagated via the filter; and
a detector device used to receive a third laser beam, wherein at least one of the first laser beam, the second laser beam and the third laser beam propagated through the filter is in a reflective approach.

8. The transmitter optical subassembly according to claim 7, wherein the dual wavelength laser device has a TO-CAN package to package a first laser chip and a second laser chip together.

9. A receiver optical subassembly, comprising:
a filter;
a transceiver device used to emit a first laser beam propagated via the filter and used to receive a second laser beam propagated via the filter, and a detector device used to receive a third laser beam, wherein at least one of the first laser beam, the second laser beam and the third laser beam propagated through the filter is in a reflective approach.

10. The receiver optical subassembly according to claim 9, wherein the transceiver device has a TO-CAN package used to package a laser chip and a detector chip together.

11. A transmitter optical subassembly, comprising:
a filter;
a laser device used to emit a first laser beam propagated via the filter; and
a transceiver device used to emit a second laser beam and used to receive a third laser beam propagated via the filter, wherein at least one of the first laser beam, the second laser beam and the third laser beam propagated through the first filter is in a reflective approach.

12. The transmitter optical subassembly according to claim 11, wherein the transceiver device has a TO-CAN package used to package a laser chip and a detector chip together.
